(19) United States
(12) Patent Application Publication
(10) Pub. No.: US 2010/0316329 A1
(43) Pub. Date: Dec. 16, 2010

(54) OPTICAL ELEMENT PACKAGE AND SUBSTRATE COMPRISING THE SAME

(76) Inventors: Han Seo CHO, Seoul (KR); Sang Hoon Kim, Gyunggi-do (KR); Joon Sung Kim, Gyunggi-do (KR); Jae Hyun Jung, Gyunggi-do (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/552,918

(22) Filed: Sep. 2, 2009

(30) Foreign Application Priority Data
Jun. 10, 2009 (KR) 10-2009-0051601

(51) Int. Cl. G02B 6/12

(52) U.S. Cl. 385/14

(57) ABSTRACT

Disclosed herein is an optical element package substrate configured such that electric wiring substrates having a cavity are layered on both sides of an optical waveguide, an optical element package is mounted in the electric wiring substrates, and an optical element mounted on the surface of the optical element package is housed in the cavity, so that the distance between the optical element and the optical waveguide is decreased, thereby increasing optical connection efficiency.

### CROSS REFERENCE TO RELATED APPLICATION

This application claims the benefit of Korean Patent Application No. 10-2009-0051601, filed Jun. 10, 2009, entitled “Package of optical element and substrate including the same”, which is hereby incorporated by reference in its entirety into this application.

### BACKGROUND OF THE INVENTION

1. Technical Field

The present invention relates to an optical element package and a substrate comprising the same.

2. Description of the Related Art

Recently, with the advancement of microprocessor technologies, the operation speed thereof has reached several tens of Gb/s. However, microprocessor technologies do not keep up with changes in high-speed data processing capacity due to the limitations of electrical connections. Thus, as an alternative to electrical connections, optical connection is becoming on the rise. Since making optical connections between chips or between boards has the advantages of high-speed signal transmission, highly-densified wiring and low energy consumption, it can be used to improve the signal processing capability in large-capacity computers and next-generation mobile communication systems.

FIG. 1 is a sectional view showing a conventional optoelectric wiring substrate disclosed in Japanese Unexamined Patent Application Publication No. 2006-330697.

Referring to the publication, the conventional optoelectric wiring substrate includes a substrate 100, an electric wiring layer 105 formed on the substrate 100, an optical wiring layer 103 formed on the electric wiring layer 105, and a light-emitting element 101 and a light-receiving element 102 which are flip-chip-bonded on the surface of the optical wiring layer 103. Here, the optical wiring layer 103 includes a core 103 and upper and lower clads 103b and 103c covering the core 103.

In this optoelectric wiring substrate, as shown by the dashed line of FIG. 1, light emitted from the light-emitting element 101 is vertically incident on the upper clad 103b, is passed through the core 103a, and is incident on the lower clad 103c. Subsequently, the light is deflected at a right angle by a mirror 104, is passed through the core 103a and the upper clad 103b, and is then incident on the light-receiving element 102.

However, the conventional optoelectric wiring substrate, shown in FIG. 1, is problematic in that, since the light-emitting element 101 and the light-receiving element 102 are flip-chip-bonded on the optical wiring layer 103, they are spaced apart from the optical wiring layer 103 by the height of the flip chip, so that the efficiency of the optical connection is decreased by the height of the flip chip.

Moreover, the conventional optoelectric wiring substrate is problematic in that, since it must be additionally mounted therein with a chip for driving the light-emitting element 101 and the light-receiving element 102 although not shown in FIG. 1, it takes a lot of time to mount the chip in the optoelectric wiring substrate, and the flexible portion of the optoelectric wiring substrate is warped by pressure at the time of mounting the chip therein.

### SUMMARY OF THE INVENTION

Accordingly, the present invention has been made to solve the above-mentioned problems, and the present invention provides an optical element package which can increase the efficiency of an optical connection by decreasing the distance between an optical element and an optical waveguide, and a substrate comprising the same.

Further, the present invention provides an optical element package which can easily mount an optical element and chips for driving the optical element thereon, and a substrate comprising the same.

An aspect of the present invention provides an optical element package, including: a carrier substrate including terminals on one side thereof; an optical element mounted on the side of the carrier substrate; and optical element driving chips mounted on the carrier substrate.

In the optical element package, the optical element driving chips are mounted on the other side of the carrier substrate opposite to the one side on which the optical element is mounted, and are covered with a resin layer formed on the other side of the carrier substrate.

Another aspect of the present invention provides an optical element package substrate, including: an optical waveguide in which an inner wiring layer is formed; electric wiring substrates which are layered on both sides of the optical waveguide and in which a cavity for accommodating an optical element and outer wiring layers are formed; and an optical element package which includes a carrier substrate provided on one side thereof with terminals and an optical element and optical element driving chips mounted on the carrier substrate, wherein, in the optical element package, the optical element is housed in the cavity, and the terminals are connected with the outer wiring layers.

In the optical element package substrate, the inner wiring layer is buried in the optical waveguide.

Further, the electric wiring substrates include: an insulation layer formed on one side of the optical waveguide; a first insulation material formed on the insulation layer; a first flexible substrate which includes a first flexible insulation layer and a first outer wiring layer formed on the first flexible insulation layer and having pads and patterns; a second insulation material formed on the other side of the optical waveguide; and a second flexible substrate which includes a second flexible insulation layer and a second outer wiring layer formed on the second flexible insulation layer.

Further, the cavity is configured to pass thorough the insulation layer, first insulation material and first flexible insulation layer, and the optical element package is mounted such that the optical element is housed in the cavity and the terminals are connected with the pads of the first outer wiring layer.

Further, the cavity has a size sufficient to accommodate the optical element of the optical element package therein, and has a width smaller than that of the optical element package such that the optical element package is placed on the surface of the electric wiring substrate.

Further, the insulation layer is made of a material including a light transmissive material.

Further, the first and second insulation materials are partially removed such that the optical waveguide and the first and second flexible substrates have flexibility.

Further, the inner wiring layer and the outer wiring layers are electrically interconnected through a via.

Further, the optical element driving chips are mounted on the other side of the carrier substrate opposite to the one side on which the optical element is mounted, and are covered with a resin layer formed on the other side of the carrier substrate.

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view showing a conventional optoelectric wiring substrate;

FIG. 2 is a sectional view showing an optical element package according to an embodiment of the present invention;

FIG. 3 is a sectional view showing an optical element package substrate according to a first embodiment of the present invention; and

FIG. 4 is a sectional view showing an optical element package substrate according to a second embodiment of the present invention.

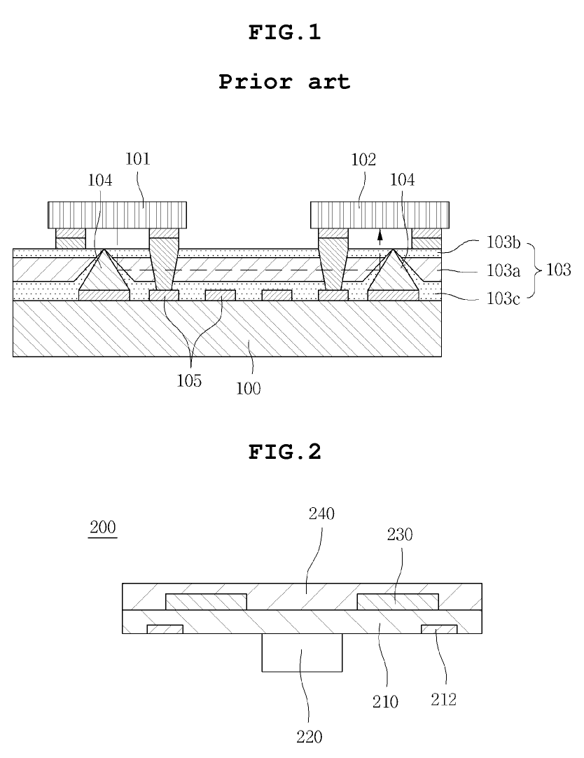

### DESCRIPTION OF THE PREFERRED EMBODIMENTS

The objects, features and advantages of the present invention will be more clearly understood from the following detailed description and preferred embodiments taken in conjunction with the accompanying drawings. Throughout the accompanying drawings, the same reference numerals are used to designate the same or similar components, and redundant descriptions thereof are omitted. In the following description, the terms “first”, “second” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

Optical Element Package

FIG. 2 is a sectional view showing an optical element package according to an embodiment of the present invention. Hereinafter, an optical element package according to an embodiment of the present invention will be described in detail with reference to FIG. 2.

As shown in FIG. 2, the optical element package 200 according to this embodiment has a structure in which an optical element 220 and chips 230 for driving the optical element 220 are mounted on a carrier substrate 210 provided with terminals 212.

Here, the terminals 212 are formed in one side of the carrier substrate 210, and the optical element 220 is mounted on the side of the carrier substrate 210.

The optical element 220 includes light-emitting elements, such as semiconductor lasers, light-emitting diodes (LEDs) and the like, and light-receiving elements, such as photodiodes (PDs) and the like.

The chips 230 for driving the optical element 220 serve to provide electric power and electric signals for driving the optical element 220, and are mounted on the surface of the carrier substrate 210. Here, the chips 230 for driving the optical element 220 are mounted on the other side of the carrier substrate 210, and are covered with a resin layer (for example, an EMC molding layer) to be protected from the external environment. Meanwhile, FIG. 2 shows the chips 230 for driving the optical element 220 mounted on the other side of the carrier substrate 210, but, in consideration of the mounting area, the chips 230 for driving the optical element 220 may be mounted on the side of the carrier substrate 210 on which the optical element 220 is mounted.

According to this embodiment, both the optical element 220 and the chips 230 for driving the optical element 230 are mounted on the carrier substrate, thus allowing more easy mounting of the optical element 220 and the chips 230 in the optical element package 200.

Optical Element Package Substrate

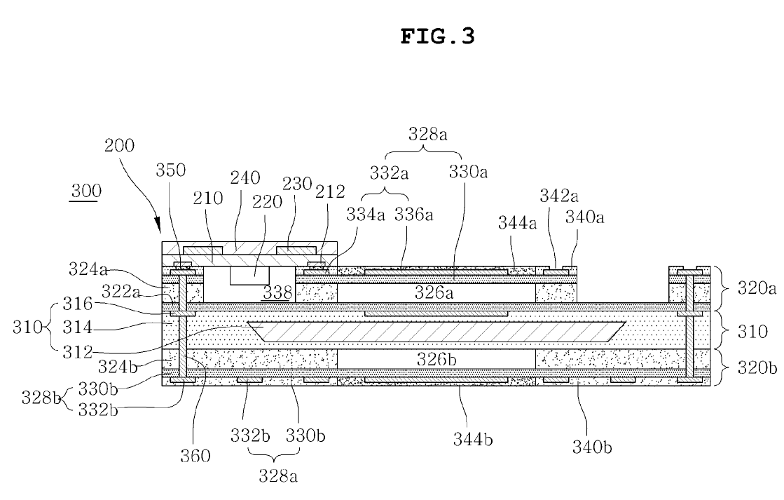

FIG. 3 is a sectional view showing an optical element package substrate according to a first embodiment of the present invention. Hereinafter, an optical element package substrate according to a first embodiment of the present invention will be described in detail with reference to FIG. 3.

As shown in FIG. 3, the optical element package substrate 300 according to a first embodiment of the present invention is configured such that electric wiring substrates 320a and 320b having a cavity 338 are layered on both sides of an optical waveguide 310, an optical element package 200 is mounted in the electric wiring substrates 320a and 320b, and an optical element 220 mounted on one side of the optical element package 200 is housed in the cavity 338, so that the distance between the optical element 220 and the optical waveguide 310 is decreased, thereby increasing optical connection efficiency.

The optical waveguide 310 serves to transmit both optical and electric signals therethrough, and includes a core 312, a clad 314 and an inner wiring layer 316.

The core 312, which serves as a pathway through which optical signals are transmitted, is covered with the clad 314, and is made of a flexible polymer or optical fiber.

The clad 314 serves to enable optical signals to be efficiently transmitted through the core 312, is configured to cover the core 312, and is designed to have a refractive index lower than that of the core 312. Like the core 312, the clad 314 may also be made of a flexible polymer or optical fiber.

The inner wiring layer 316 serves to transmit electric signals, and is formed in the clad 314. In order to efficiently design wiring, the inner wiring layer 316 may be buried in the optical waveguide 310, that is, the clad 314.

The electric wiring substrates 320a and 320b serve to transmit electric signals, are layered on both sides of the optical waveguide 310, and include the cavity 338 for accommodating an optical element 220 and outer wiring layers 332a and 332b.

For example, in the electric wiring substrate 320a, an insulation layer 322a, a first insulation material 324a and a first flexible substrate 328a in which a first outer wiring layer 332a is formed on a first flexible insulation layer 330a are layered on one side of the optical waveguide 310, and, in the electric wiring substrate 320b, a second insulation material 324b and a second flexible substrate 328b in which a second outer wiring layer 332b is formed on a second flexible insulation layer 330b are layered on the other side of the optical waveguide 310. In this case, the first outer wiring layer 332a, inner wiring layer 316 and second outer wiring layer 332b are electrically interconnected through a via 360.

Here, the insulation layer 322a is formed on one side of the optical waveguide 310 in order to cover the inner wiring layer 316, and is made of a material including a light transmissive material in order to enable light to be transmitted between the optical element 220 and the optical waveguide 310 therethrough. Meanwhile, FIG. 3 shows the insulation layer 322a additionally provided in order to cover the inner wiring layer 316. However, as described later, in the present invention, since the entire optical element package 200 is closely mounted on the surface of the first electric wiring substrate 320a to isolate the cavity 338 from the external environment, the insulation layer 322a may not be additionally provided in order to cover the inner wiring layer 316, and such a configuration can also be included in the scope of the present invention. Moreover, FIG. 3 shows the insulation layer 322a formed on one side of the optical waveguide 310, but the insulation layer 322a may be formed on the other side of the optical waveguide 310, and such a configuration can also be included in the scope of the present invention.

The first insulation material 324a and second insulation material 324b are layered on both sides of the optical waveguide 310 such that they are partially removed to have openings 326a and 326b in order to impart flexibility to the optical waveguide 310 and electric wiring substrates 320a and 320b. Like this, since the first insulation material 324a and second insulation material 324b have the openings 326a and 326b, an optical element package substrate is able to have both flexibility and rigidity although they are made of a rigid material.

The first flexible substrate 328a and second flexible substrate 328b function as outer circuit layers formed on the outside of the optical waveguide 310, and serve to transmit electric power and electric signals. Specifically, the first flexible substrate 328a has a structure in which the first outer wiring layer 332a is formed on the first insulation material 324a, and the second flexible substrate 328b has a structure in which the second outer wiring layer 332b is formed on the second insulation material 324b. In this case, the first flexible substrate 328a includes pads 334a and patterns 336a. The first flexible substrate 328a and second flexible substrate 328b are covered with solder resists 340a and 340b and coverlays 344a and 344b.

The cavity 338 for accommodating an optical element is configured to pass through the insulation layer 322a, first insulation material 324a and first flexible insulation layer 330a. Here, the cavity 338 for accommodating an optical element has a size to sufficient to accommodate the optical element of the optical element package 200 therein, and has a width smaller than that of the optical element package 200 such that the optical element package 200 is placed on the surface of the first electric wiring substrate 320a.

The optical element package 200 has a structure, shown in FIG. 2, in which it is mounted on the first electric wiring substrate 320a in a state in which its terminals 212 are connected with the pads 334a of the first outer wiring layer 332a. In this case, the optical element 220 mounted on one side of the carrier substrate 210 of the optical element package 200 is housed in the cavity 338. That is, in this embodiment, the optical element 220 is housed in the cavity 338, so that the distance between the optical element 220 and the optical waveguide 310 is decreased, thereby increasing the efficiency of the optical connection. Here, openings for exposing the pads 334a are formed in a solder resist 350, and the terminals 212 of the optical element package 200 are connected with the pads 334a using the solder resist 350.

Meanwhile, FIG. 3 shows an optical element package substrate 300 on which one optical element package is mounted, but this is adapted to meet the convenience of illustration. Moreover, it is shown in FIG. 3 that the cavity 338 for accommodating an optical element is formed only in the first electric wiring substrate 320a and the optical element package 200 is mounted on the first electric wiring substrate 320a, but the cavity 338 for accommodating an optical element may be formed even in the second electric wiring substrate 320b and the optical element package 200 may be mounted in this cavity 338, and such a configuration can also be included in the scope of the present invention.

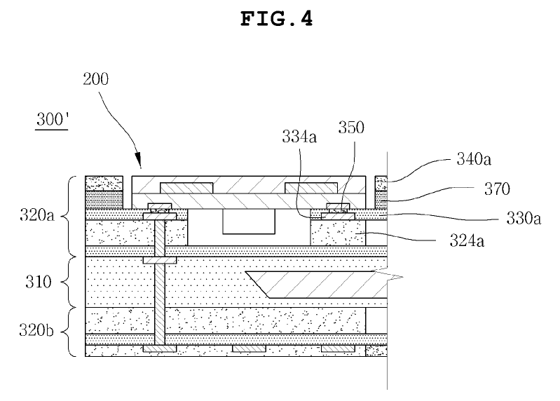

FIG. 4 is a partial sectional view showing an optical element package substrate according to a second embodiment of the present invention. In the description and illustration of this embodiment, the same reference numerals are used to designate the same or similar components to those of the first embodiment of the present invention. Hereinafter, an optical element package substrate according to a second embodiment of the present invention will be described in detail with reference to FIG. 4.

As shown in FIG. 4, the optical element package substrate 300′ according to a second embodiment of the present invention, like the optical element package substrate 300 shown in FIG. 4, is also configured such that a cavity 338 is formed in an electric wiring substrate 320a, and an optical element 220 is housed in the cavity 338, so that the distance between the optical element 220 and the optical waveguide 310 is decreased, thereby increasing the efficiency of the optical connection. In particular, the optical element package substrate 300′ is characterized in that a stepped cavity is formed in the electric wiring substrates 320a using an additional insulation layer 370, and thus the entire optical element package 200 is housed in the stepped cavity.

Specifically, in this embodiment, the first electric wiring substrate 320a has a structure in which the first flexible insulation layer 330a and additional insulation layer 370 are layered on the first insulation material 324a provided thereon with the first outer wiring layer 332a. Here, a cavity having a size in which the optical element 220 is able to be housed therein is formed in the first insulation material 324a and first flexible insulation layer 330a, and a cavity having a size such that the entire optical element package 200 may be housed therein is formed in the additional insulation layer 370, thereby fabricating an optical element package substrate provided therein with the optical element package 200.

In this case, the optical element package 200 is fixedly placed on the first flexible insulation layer 330a in a state in which its terminals 212 are connected with pads 334a through solder resists 350.

According to the present invention, an optical element package comprising an optical element and chips for driving the optical element is provided, thus increasing mounting efficiency.

Further, according to the present invention, a cavity is formed in electric wiring substrates layered on an optical waveguide, and an optical element is housed in the cavity, so that the distance between the optical element and the optical waveguide is decreased, thereby increasing the efficiency of optical connection.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Simple modifications, additions and substitutions of the present invention belong to the scope of the present invention, and the specific scope of the present invention will be clearly defined by the appended claims.

What is claimed is:

1. An optical element package, comprising:
a carrier substrate including terminals on one side thereof;
an optical element mounted on the side of the carrier substrate; and
optical element driving chips mounted on the carrier substrate.

2. The optical element package according to claim 1, wherein the optical element driving chips are mounted on the other side of the carrier substrate opposite to the one side on which the optical element is mounted, and are covered with a resin layer formed on the other side of the carrier substrate.

3. An optical element package substrate, comprising:
an optical waveguide in which an inner wiring layer is formed;
electric wiring substrates which are layered on both sides of the optical waveguide and in which a cavity for accommodating an optical element and outer wiring layers are formed; and
an optical element package which includes a carrier substrate provided on one side thereof with terminals and an optical element and optical element driving chips mounted on the carrier substrate,
wherein, in the optical element package, the optical element is housed in the cavity, and the terminals are connected with the outer wiring layers.

4. The optical element package substrate according to claim 3, wherein the inner wiring layer is buried in the optical waveguide.

5. The optical element package substrate according to claim 3, wherein the electric wiring substrates comprise:
an insulation layer formed on one side of the optical waveguide;
a first insulation material formed on the insulation layer;
a first flexible substrate which includes a first flexible insulation layer and a first outer wiring layer formed on the first flexible insulation layer and having pads and patterns;
a second insulation material formed on the other side of the optical waveguide; and
a second flexible substrate which includes a second flexible insulation layer and a second outer wiring layer formed on the second flexible insulation layer.

6. The optical element package substrate according to claim 5, wherein the cavity is configured to pass thorough the insulation layer, first insulation material and first flexible insulation layer, and the optical element package is mounted such that the optical element is housed in the cavity and the terminals are connected with the pads of the first outer wiring layer.

7. The optical element package substrate according to claim 3, wherein the cavity has a size sufficient to accommodate the optical element of the optical element package therein, and has a width smaller than that of the optical element package such that the optical element package is placed on the surface of the electric wiring substrate.

8. The optical element package substrate according to claim 5, wherein the insulation layer is made of a material including a light transmissive material.

9. The optical element package substrate according to claim 5, wherein the first and second insulation materials are partially removed such that the optical waveguide and the first and second flexible substrates have flexibility.

10. The optical element package substrate according to claim 3, wherein the inner wiring layer and the outer wiring layers are electrically interconnected through a via.

11. The optical element package substrate according to claim 3, wherein the optical element driving chips are mounted on the other side of the carrier substrate opposite to the one side on which the optical element is mounted, and are covered with a resin layer formed on the other side of the carrier substrate.
